(19) United States
(12) Patent Application Publication
(10) Pub. No.: US 2010/0192776 A1
(43) Pub. Date: Aug. 5, 2010

(54) DUST SEPARATING APPARATUS HAVING ADJUSTABLE DUST COLLECTING SPACE

(76) Inventors: Jang-keun Oh, Gwangju-city (KR); Byung-Jo Lee, Gwangju-city (KR); Seung-Yong Cha, Gwangju-city (KR)

Correspondence Address: North Star Intellectual Property Law, PC, P.O. Box 34688, Washington, DC, 20043, US

(21) Appl. No.: 12/623,380

(22) Filed: Nov. 21, 2009

(30) Foreign Application Priority Data
Feb. 3, 2009 (KR) 10-2009-0008325
Apr. 10, 2009 (KR) 10-2009-0034166

(51) Int. Cl. B01D 45/12; B01D 46/46

(52) U.S. Cl. 96/405; 55/430; 55/414; 55/393; 55/404

(57) ABSTRACT

A dust separating apparatus is provided. The dust separating apparatus draws in an external air stream and separates dust particles from the drawn air stream. The dust separating apparatus may include a dust collecting space to store dust particles and a driving means to increase or decrease the dust collecting space. Accordingly, a user may adjust the capacity of the dust collecting space as desired.

### CROSS-REFERENCE TO RELATED APPLICATIONS

This application claims the benefit under 35 U.S.C. §119(a) of a Korean Application No. 2009-0008325, filed Feb. 3, 2009, and a Korean Application No. 2009-0031466, filed Apr. 10, 2009, in the Korean Intellectual Property Office, the entire disclosures of which are incorporated herein by reference for all purposes.

### BACKGROUND

1. Field

The following disclosure relates to a vacuum cleaner, and more particularly, to a dust separating apparatus that may be mounted to a domestic, industrial and commercial vacuum cleaner to separate dust particles from air stream.

2. Description of the Related Art

A dust separating apparatus employed in a vacuum cleaner may operate to filter out dust particles from air stream. Recently, bagless, or cyclone dust separating apparatuses, which do not need disposable dust bags, have been used widely.

Although a bagless, or cyclone dust separating apparatus may be used repeatedly, a user still has to empty collected dust particles whenever a dust collecting space is full. The size of the dust collecting space of the dust separating apparatus is in relation with not only the dust disposal interval, but also the size of the dust separating apparatus and the size (i.e., volume) of the vacuum cleaner. In other words, the dust collecting space should be sized appropriately, in accordance with the amount of dust of a place being cleaned. The user may be inconvenienced if the dust collecting space is too large, or too small compared to the amount of dust collected.

A conventional dust separating apparatus of a vacuum cleaner may generally have a dust capacity which is fixed according to each model type, and therefore, the user is not able to adjust the space as he wishes. Accordingly, under different conditions, by way of example, if the user wants to clean different places, the size of the dust collecting space may not be suitable for the new cleaning places, in which case the user may be inconvenienced.

### SUMMARY

In one general aspect, a dust separating apparatus of a vacuum cleaner, drawing in an external air stream and separating dust particles from the drawn air stream is provided. The dust separating apparatus may include a dust collecting space to store dust particles and a driving device to increase or decrease the dust collecting space.

The dust separating apparatus may further include a cyclone chamber formed in an upper portion of the dust collecting space, to spin the air stream and cause the dust particles to be separated from the air stream.

The cyclone chamber is a space which may be separate from the dust collecting space.

The dust collecting space may further include a compressing member to compress collected dust.

The driving device may be formed in a main body of the vacuum cleaner.

In another aspect, a dust separating apparatus housed in a corresponding receiving space defined within a main body of a vacuum cleaner to separate dust particles from an air stream is provided. The dust separating apparatus may include a cyclone separator and a dust receptacle arranged below the cyclone separator to form a dust collecting space and to receive the dust particles separated in the cyclone separator, a driving device formed in the main body of the vacuum cleaner, and a driving force transmitting device to transmit a driving force of the driving device to the dust receptacle. The dust receptacle may include at least two receptacles and the driving device may increase or decrease the dust collecting space by moving the at least two receptacles in relation with each other.

The dust receptacle may include a first and second receptacle, in which the first receptacle is secured to the cyclone separator and the first and second receptacles are moved in relation with each other.

The dust separating apparatus is in mesh with the driving device when mounted in the main body of the vacuum cleaner, and separated from the driving device when removed from the main body of the vacuum cleaner.

The driving force transmitting device may include a screw member.

The driving force transmitting device may include a rack and a pinion.

The driving device may be stopped automatically if overload is detected.

The cyclone separator may be formed in a manner in which an axis of rotation of the drawn air stream is approximately horizontal, and the cyclone separator is connected to the dust collecting space by a dust outlet.

The dust receptacle further comprises a compressing member which compresses the dust particles.

In still another aspect, a dust separating apparatus having an adjustable volume dust collecting space for collecting dust particles separated from an external air stream by a cyclone separator is provided. The dust separating apparatus may include a dust receptacle surrounding a dust collecting space having a volume, the dust receptacle including a first dust receptacle and a second dust receptacle, and a driving device. One of the first dust receptacle and the second dust receptacle is movable relative to the other of the first dust receptacle and second dust receptacle to thereby adjust the volume of the dust collecting space.

The driving device provides a driving force to move the one of the first dust receptacle and the second dust receptacle relative to the other of the first dust receptacle and second dust receptacle to thereby adjust the volume of the dust collecting space.

The dust separating apparatus may further include a driving force transmission device positioned between the driving device and one of the first receptacle and second receptacle.

The dust separating apparatus may further include a discharge duct including a discharge duct inner pipe and a discharge duct outer pipe. The discharge outer pipe may be moved relative to the discharge duct inner pipe during adjustment of the volume of the dust collecting space.

The dust separating apparatus may further include an inlet duct positioned adjacent to, and parallel with, the discharge duct. The inlet duct may include an inlet duct inner pipe and an inlet duct outer pipe. The inlet duct outer pipe may be moved relative to the inlet duct inner pipe during adjustment of the volume of the dust collecting space.

Other features and aspects will be apparent from the following detailed description, the drawings, and the claims.

### BRIEF DESCRIPTION OF THE DRAWINGS

FIG. 1 is a diagram illustrating a perspective view of an exemplary dust separating apparatus being mounted to a main body of a vacuum cleaner according to a first exemplary embodiment.

FIG. 2 is a diagram illustrating a perspective view cut along a line II-II of FIG. 1.

FIG. 3 is a diagram illustrating a cross section view cut along line III-III of FIG. 1.

FIG. 4 is a diagram illustrating a cross section view of the exemplary dust separating apparatus of the vacuum cleaner according to the first exemplary embodiment, illustrating a dust collecting space extended to have a maximum capacity.

FIG. 5 is a diagram illustrating a perspective view of an exemplary dust separating apparatus being mounted to a vacuum cleaner according to a second exemplary embodiment.

FIG. 6 is a diagram illustrating a perspective view of the exemplary dust separating apparatus of the vacuum cleaner according to the second exemplary embodiment.

FIG. 7 is a diagram illustrating a cross section view cut along a line VII-VII of FIG. 6, illustrating the dust collecting space with minimum capacity (in solid line) and in maximum capacity (in two-dotted line).

FIG. 8 is a diagram illustrating a cross section view of the exemplary dust separating apparatus according to the second exemplary embodiment, which includes a compressing member below a lower surface of a cyclone separator.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

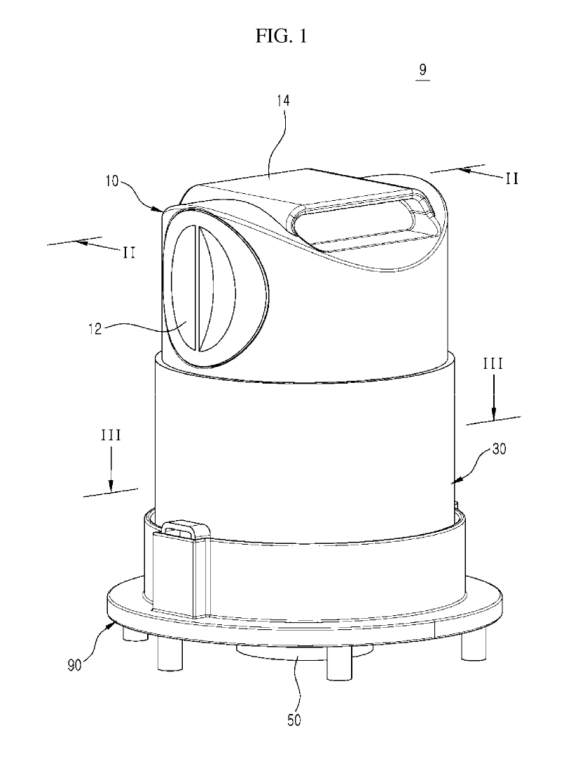

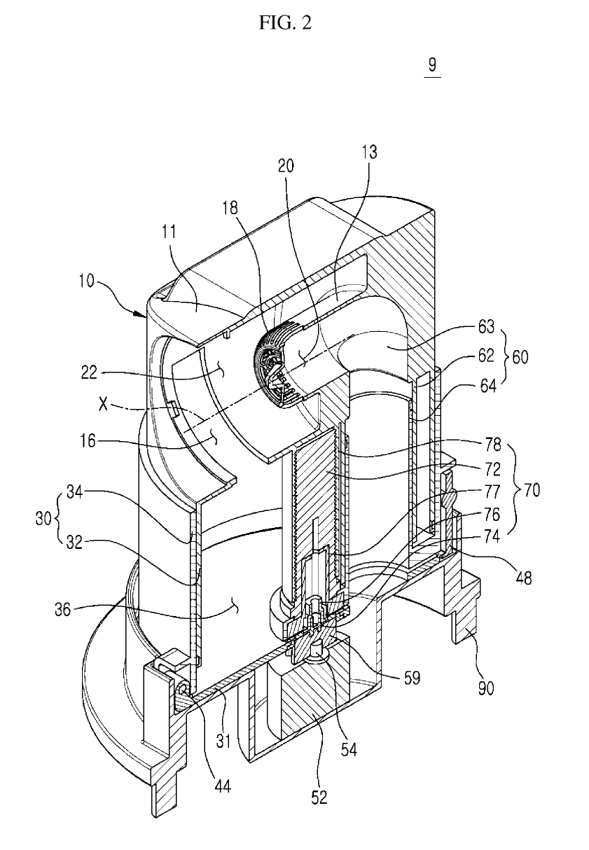

FIGS. 1 to 4 illustrate an exemplary dust separating apparatus of a vacuum cleaner according to a first exemplary embodiment. FIGS. 1 and 2 partially illustrate a main body 90 of the vacuum cleaner. That is, a lower portion of the space to receive the dust separating apparatus therein, is illustrated.

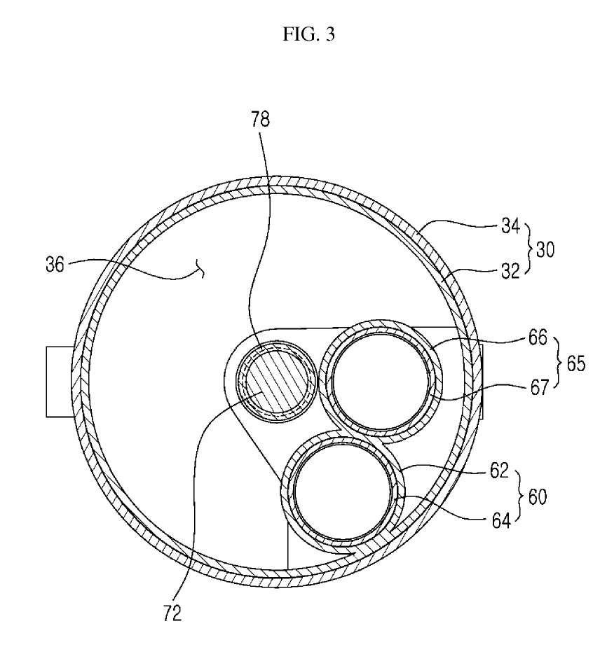

Referring to FIGS. 1 and 2, the exemplary dust separating apparatus 9 according to the first exemplary embodiment may be removably mounted to the main body 90 of the vacuum cleaner, and may include a cyclone separator 10, a dust receptacle 30, a driving force transmitting device 70, a driving device which may include a driving motor 52, a discharge duct 60, and an inlet duct 65 (FIG. 3).

The cyclone separator 10 may include a cyclone tub 11, an inlet (not illustrated), an outlet 20, an exhaust pipe 13, a grill member 18, and a dust outlet 16. The cyclone tub 11 may be formed in a cylindrical shape which is horizontally placed, for example, and the outlet 20 may be formed in one side of the cyclone tub 11. The exhaust pipe 13 may extend from the outlet 20 and protrude into the cyclone chamber 22, and the grill member 18 may be attached to one end of the exhaust pipe 13. The dust outlet 16 may be formed in an approximately square shape, for example, in a circumferential direction of the cyclone tub 11.

The dust receptacle 30 may include a first receptacle 32, a second receptacle 34, and a bottom plate 31, forming the dust collecting space 36 therein.

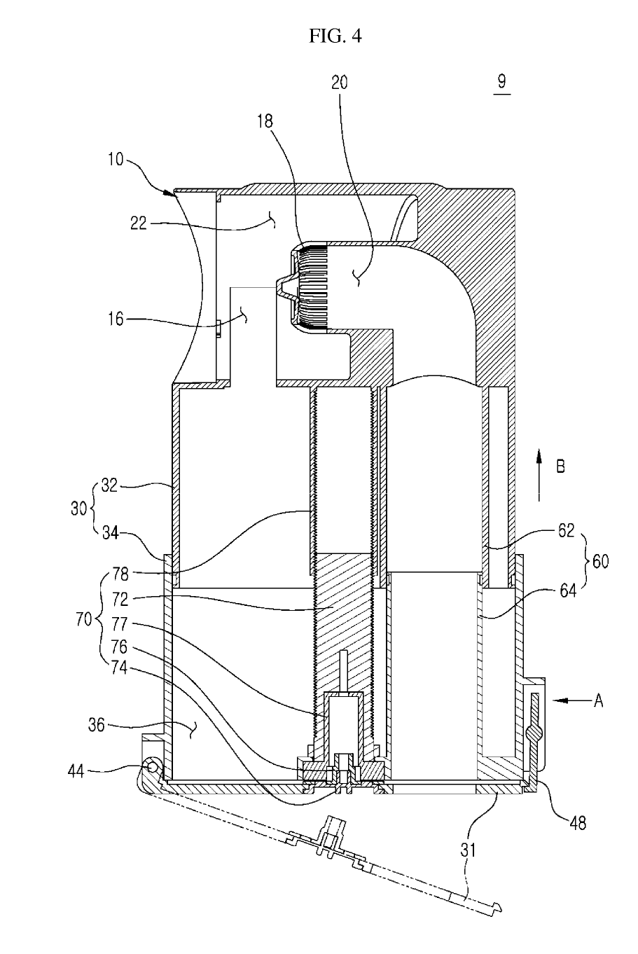

The first and second receptacles 32, 24 may be bottomless cylinders, in which the first receptacle 32 may be secured to the cyclone tub 11, and the second receptacle 34 may be formed to wrap around the outer circumference of the first receptacle 32. The bottom plate 31 may be a circular plate which opens or closes the lower surface of the second receptacle 34, in which one end may be rotatably connected to a side of lower portion of the second receptacle 34, and the other end may be locked in an unhook member 48 formed on the other side of the second receptacle 34. Referring to FIG. 4, the bottom plate 31 may be selectively opened to allow disposal of the dust from the dust collecting space 36, if the unhook member 48 at the side of the second receptacle 34 is pressed in an arrowed direction ‘A’. If the dust separating apparatus 9 is mounted to the main body 90 of the vacuum cleaner as illustrated in FIGS. 1 and 2, the second receptacle 34 and the bottom plate 31 may be supported in contact with the main body 90 of the vacuum cleaner.

Referring to FIGS. 2 to 4, the driving force transmitting device 70 may include a screw pillar 78, a screw member 72, a connecting member 74, and first and second couplings 76, 77. The screw pillar 78 may be formed as a cylindrical pillar, for example, having a female screw thread formed on an inner surface. An upper end of the screw pillar 78 may be secured to an outer circumference of the cyclone tub 11. The screw member 72 may also include a screw thread formed on an outer circumference, and inserted in the screw pillar 78 to be engaged with the screw thread on the inner circumference of the screw pillar 78. The connecting member 74 may be rotatably formed on the bottom plate 31, to be rotated in mesh with the motor shaft 54 or separated from the motor shaft 54 in accordance with the mounting or removal of the dust separating apparatus 9 to or from the main body 90 of the vacuum cleaner. The first and second couplings 76, 77 may be formed between the screw member 72 and the connecting member 74 to connect the screw member 72 and the connecting member 74. That is, the first coupling 76 may be connected to the connecting member 74, and the second coupling 77 may be connected to the screw member 72. If the bottom plate 31 is open, the first coupling 76 may be separated from the second coupling 77, leaving the second coupling 77, together with the screw member 72, suspended on the screw pillar 78.

Referring to FIGS. 1 and 2, the driving motor 52 may be formed in a driving motor chamber 50 which may be provided in the main body 90 of the vacuum cleaner and under the dust separating apparatus 9. An axis connecting member 59, which may be connected in mesh with the connecting member 74 of the driving force transmitting device 70, may be connected to the motor shaft 54. Accordingly, the driving force of the motor may be transmitted to the connecting member 74 through the motor shaft 54 and the axis connecting member 59.

Referring to FIGS. 3 and 4, the discharge duct 60 and the inlet duct 65 may be formed vertically and in parallel relation with each other. Although FIG. 2 illustrates the discharge duct 60 only, FIG. 3 shows the inlet duct 65 may be formed adjacent to the discharge duct 60. The discharge duct 60 and the inlet duct 65 may include a discharge duct outer pipe 62 and an inlet duct outer pipe 66, respectively. Additionally, the discharge duct 60 and the inlet duct 65 may include a discharge duct inner pipe 64 and an inlet duct inner pipe 67, respectively. The outer pipe 62 of the discharge duct 60 may be secured to the cyclone tub 11 so as to be connected fluidly with a fluid passage 63 which may be formed in ‘┐’ shape and which may be connected to the outlet 20 formed on a side of the cyclone tub 11. The outer pipe 66 of the inlet duct 65 may also be secured to the cyclone tub 11 so as to be connected fluidly with an inlet (not illustrated) which may be formed in a tangential direction of the cyclone tub 11. Referring to FIG. 3, each of the inner pipes 64, 67 of the discharge duct 60 and the inlet duct 65 may be secured to the bottom plate 31. Accordingly, the outer pipes 62, 66, along with the cyclone tub 11 and the first receptacle 32, may be moved in relation with the second receptacle 34 and the bottom plate 31. By way of example, the inner pipes 64, 67 may be respectively inserted in the outer pipes 62, 66 if the dust receptacle 30 is retracted, while the inner pipes 64, 67 may be protruded downward if the dust receptacle 30 is extended. As a result, the overall length of the discharge duct 60 and the inlet duct 65 may be increased or decreased as long as the length of extension or retraction of the dust receptacle 30.

Although not illustrated, an electric current sensor and a control unit may be provided in the main body 90 of the vacuum cleaner. The electric current sensor may measure in real time an amount of electric current supplied to the driving motor 52 to detect overload of the driving motor 52. The control unit may control the operation of the driving motor 52.

The operation of the dust separating apparatus 9 is explained below with reference to FIGS. 1 to 4.

When the vacuum cleaner starts driving, air stream may be drawn through a brush assembly (not illustrated) and the inlet duct 65 of the dust separating apparatus 9. The air stream may be spun as it enters into the cyclone tub 11 through the entrance of the cyclone separator 10. Dust particles with strong centrifugal force may be separated from the spinning air stream and fall into the dust collecting space 36 through the dust outlet 16. The cleaned air stream may then be discharged through the grill member 18 and the outlet 20. After being discharged through the discharge duct 60 and the lower portion of the bottom plate 31, the air stream may be discharged out of a vacuum generating device (not illustrated).

The cyclone separator 10 may be placed horizontally, the rotational axis of the air stream may be horizontal, and the cyclone separator 10 may be connected fluidly with the dust collecting space 36 only through the dust outlet 16. Accordingly, unlike an upright cyclone structure which has no distinction between the cyclone chamber 22 and the dust collecting space 36, dust of the dust collecting space 36 of the horizontal cyclone separator 10 may be limited, or not allowed, to flow backward due to a spinning air stream of the cyclone chamber 22.

The user of the vacuum cleaner may be allowed to adjust the capacity, or volume, of the dust receptacle 30 in accordance with the environment of the place being cleaned. More specifically, the user may increase or decrease the capacity before or during the operation of the vacuum cleaner, without taking out or even touching the dust separating apparatus 9.

If a user wants to increase the capacity of the dust receptacle 30 to clean a heavily dust-laden area or a large area such as a shop, a factory, or the like, the user may rotate the driving motor 52 in a forward direction. As the driving motor 52 drives, the axis connecting member 59 and the connecting member 74 connected to the motor 52 may be rotated, and the screw member 72 connected through the first and second couplings 76, 77 may also be rotated. Since the driving motor 52 is rotated in a forward direction, the screw member 72 may be rotated in a forward direction, and the screw pillar 78, screw-coupled with the screw member 72, may be moved to an upper side of the second receptacle 34, pushing the first receptacle 32 and the cyclone separator 10 in an upward direction. Referring to FIG. 4, if the screw pillar 78 is moved to a position where the dust collecting space 36 has the maximum capacity, the cyclone separator 10 and the first receptacle 32 are not allowed to move further. As a result, electric current supplied to the driving motor 52 increases. The electric current sensor detects this increase, and outputs an overload of the driving motor 52 to the control unit. As a result, the control unit cuts off electricity to the driving motor 52, and the driving motor 52 stops operation.

If the user needs to clean an area where dust is relatively less, such as a room or an office, for example, the user may decrease the capacity of the dust collecting space 36 by driving the driving motor 52 in a backward direction. As the driving motor 52 is rotated backward, the screw member 72 may be rotated backward, and accordingly, the screw pillar 78 connected to the screw member 72 may be moved downward with respect to the screw member 72. As a result, the cyclone separator 10 and the first receptacle 32, connected to the screw pillar 78, may be moved downward with respect to the second receptacle 34, decreasing the dust collecting space 36. As when the driving motor 52 is rotated in a forward direction such that dust collecting space reaches the maximum capacity, the driving motor 52 is overloaded if the dust collecting space is decreased to have the minimum capacity (FIG. 2). As a result, the electric current sensor detects the overload, and the control unit stops the driving motor 52. In addition to driving the driving motor 52 to an extent that the dust collecting space 36 has the maximum or minimum capacity, it is also possible for the user to stop the driving motor 52 when the dust collecting space 36 has a predetermined height. Conventional techniques to drive the driving motor 52 in forward and backward directions, and to control the driving motor 52 may be applied. As such, detailed explanation of such techniques is omitted for conciseness.

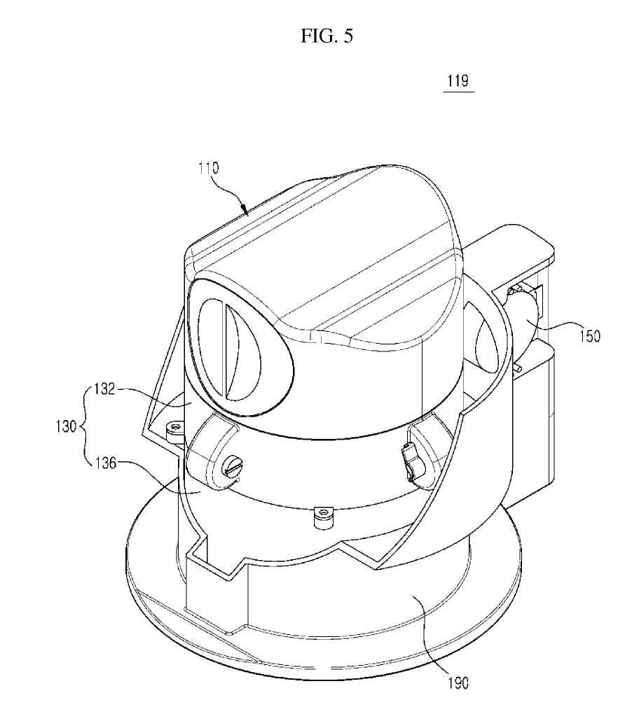

FIGS. 5 to 7 illustrate an exemplary dust separating apparatus 119 according to a second exemplary embodiment.

The dust separating apparatus 119 according to the another exemplary embodiment may include a cyclone separator 110, a dust receptacle 130, a driving force transmitting device 170, a driving device which may include a driving motor 150, a discharge duct 160, and an inlet duct (not illustrated).

The cyclone separator 110, the dust receptacle 130 having the first and second receptacles 132, 134, the discharge ducts 160 and the inlet duct having inner and outer pipes 162, 164, may have like or similar constructions as those explained above in the first exemplary embodiment. Accordingly, only the location of the driving motor 150 and the driving force transmitting device 170 are further explained below.

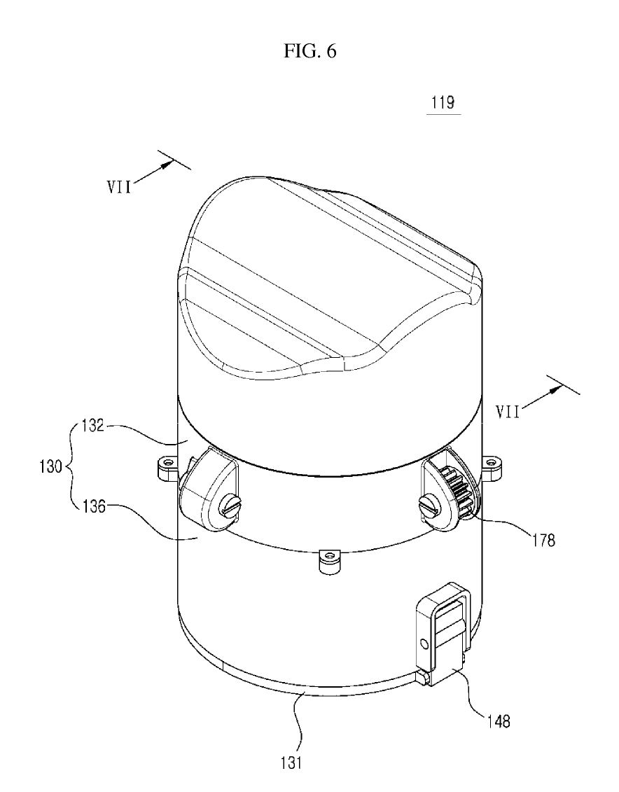

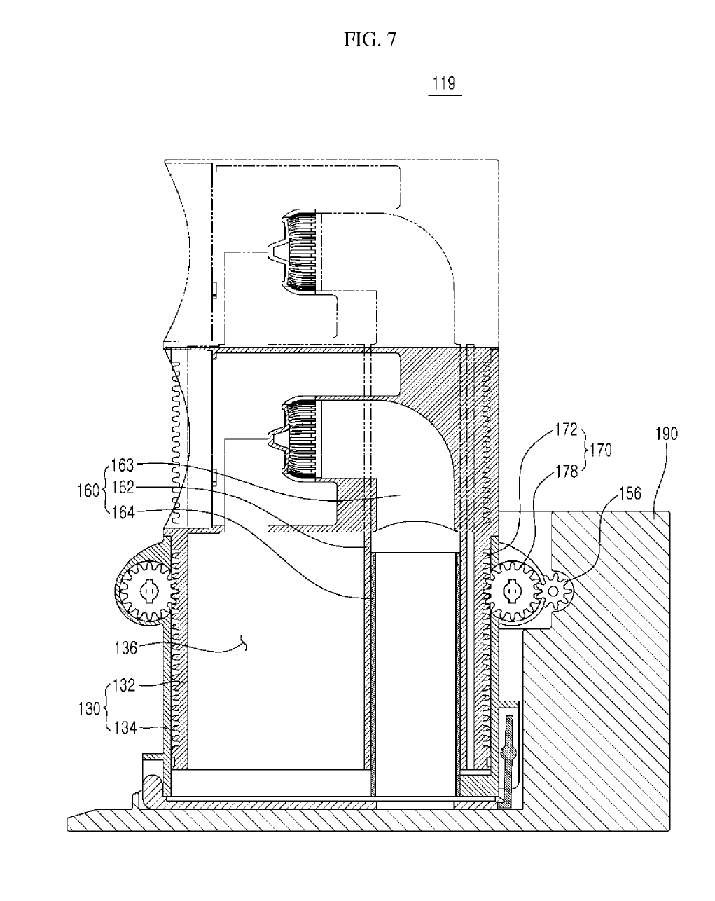

Compared to the first exemplary embodiment, the driving motor 150 may be formed in a main body 190 of the vacuum cleaner, on a side of the dust separating apparatus 119 (FIGS. 5 and 6). The driving motor 150 may be placed horizontally, and a shaft gear 156 may be provided to an end of the motor shaft (not illustrated). The shaft gear 156 may be protruded into a dust collecting chamber receiving space of the vacuum cleaner (FIG. 7).

Referring to FIG. 7, the driving force transmitting device 170 may include a rack 172 and a pinion 178. The rack 172 may be formed vertically on an outer circumference of the first receptacle 132, and the pinion 178, which may be screw-coupled with the rack 172, may be passed through the second receptacle 134. One side of the pinion 178 may be coupled to the rack 172, and the other side may be connected to the shaft gear 156 of the driving motor 150.

Similar to the first exemplary embodiment, one end of the bottom plate 131 may be rotatably secured to the second receptacle 134, and the other end may be locked to the unhook member 148 (FIG. 6).

The variable operation of the dust receptacle of the dust separating apparatus 119 according to the second exemplary embodiment is explained below, mainly focusing on the differences from the first exemplary embodiment.

If the user rotates the driving motor 150 in a forward direction, the shaft gear 156 of the driving motor 150 may be rotated, and the pinion 178, connected to the shaft gear 156, may be rotated to move the rack 172 upward. Since the rack 172 may be secured to the first receptacle 132, the first receptacle 132 may be moved in an upward direction with respect to the second receptacle 134, and the connected cyclone separator 110 may also be moved upward. Similar to the first exemplary embodiment, the outer pipes 162 of the inlet duct (FIG. 3) and the discharge duct 160 may be moved upward in accordance with the movement of the first receptacle 132. If the driving motor 150 is rotated in a backward direction, the rack 172 may be moved downward, and the first receptacle 132 may be moved downward, decreasing the dust collecting space 136. Referring to FIG. 7, the dust collecting space 136 in the state indicated by the two-dotted line has approximately the maximum capacity, while the dust collecting space 136 in the state indicated by the solid line has approximately the minimum capacity. The motor 150 may be controlled by measuring electric current, as explained above in the first exemplary embodiment. The reference numeral 163 denotes a fluid passage which corresponds to the fluid passage 63 of the first exemplary embodiment.

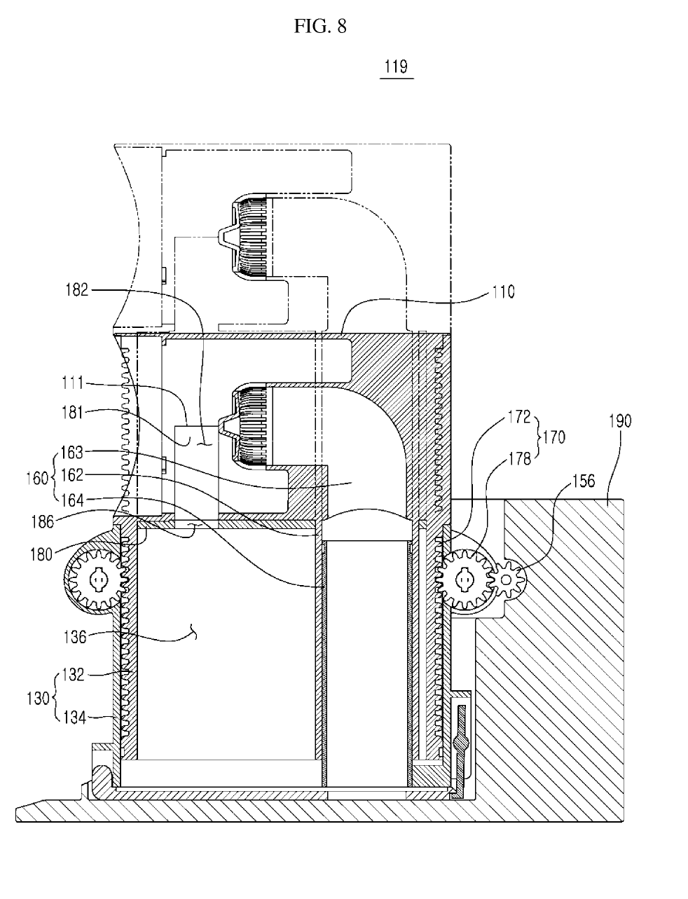

FIG. 8 is a cross section view of a dust separating apparatus 119 additionally including a compressing member 180 formed below the cyclone separator 110, according to the second exemplary embodiment.

According to the second exemplary embodiment, the dust separating apparatus 119 may include a compressing member 180 formed in the dust receptacle 130 to compress the collected dust, when the dust collecting space 136 is decreased.

The compressing member 180 may be formed as a plate having a shape corresponding to a horizontal section, and more particularly, to the inner diameter of the first receptacle 132, or a plate having a center protruding downward.

The compressing member 180 may be formed independently and attached to the lower surface of the cyclone separator 110, or formed integrally with the lower surface of the cyclone separator 110. In the latter case, the compressing member 180 may be extended radially along an outer circumference of the cyclone separator 110.

The compressing member 180 may be formed at a predetermined distance from the lower surface of the cyclone separator 110, and a surface thereof may be fixed in contact with the inner surface of the first receptacle 132 and with the outer surfaces of the discharge duct 160 and the inlet duct (not illustrated) which pass through the compressing member 180.

As explained above, the compressing member 180 may have various constructions, and include a compressing member dust outlet 186 pierced through a surface that faces the dust outlet 111 of the cyclone separator 110. An area between the compressing member dust outlet 186 and the dust outlet 111 may be formed into a dust passage 182 by a sidewall 181 which connects the entire outer circumferences of the compressing member dust outlet 186 and of the dust outlet 111.

The dust passage 182, which may be formed by the sidewall 181, isolates an area where dust is moved between the dust outlet 111 of the cyclone separator 110 and the compressing member dust outlet 186, thereby preventing diffusion of dust separated in the cyclone separator 110 to an area other than the dust collecting space 136.

The compressing member 180 with the above-explained construction may operate to compress the dust of the dust collecting space 136, by moving in a downward direction along with the cyclone separator 110, if the dust collecting space 136 is in a retracted position. Accordingly, the dust separating apparatus 119 according to the second exemplary embodiment may further increased variable capacity of the dust collecting space 136.

The compressing member 180 of the dust separating apparatus 119 according to the second exemplary embodiment may be adapted equally to the dust separating apparatus 9 of the first exemplary embodiment.

As explained above, a user may be enabled to adjust the capacity of the dust collecting space appropriately in accordance with the environment of the place being cleaned. Accordingly, increased user convenience may be provided.

Furthermore, since it is possible to adjust the dust collecting space using a driving force of the driving motor, the user does not have to take out or touch the dust separating apparatus. The user may also be able adjust the dust collecting space with convenience even when the vacuum cleaner is in operation.

Furthermore, since the dust may be compressed, the dust collecting space can have further increased capacity.

Furthermore, since it may be possible to adjust the variable capacity of the dust collecting space without affecting the cyclone separator, dust separation efficiency may be maintained constant.

Furthermore, the possibility that the dust of the dust collecting space flows backward through a cyclone discharge port, may be decreased.

A number of exemplary embodiments have been described above. Nevertheless, it will be understood that various modifications may be made. For example, suitable results may be achieved if the described techniques are performed in a different order and/or if components in a described system, architecture, device or circuit are combined in a different manner and/or replaced or supplemented by other components or their equivalents. Accordingly, other implementations are within the scope of the following claims.

What is claimed is:

1. A dust separating apparatus of a vacuum cleaner, drawing in an external air stream and separating dust particles from the drawn air stream, the dust separating apparatus comprising:
a dust collecting space to store dust particles; and
a driving device to increase or decrease the dust collecting space.

2. The dust separating apparatus of claim 1, further comprising a cyclone chamber formed in an upper portion of the dust collecting space, to spin the air stream and cause the dust particles to be separated from the air stream.

3. The dust separating apparatus of claim 2, wherein the cyclone chamber is a space which is separate from the dust collecting space.

4. The dust separating apparatus of claim 1, wherein the dust collecting space further comprises a compressing member to compress collected dust.

5. The dust separating apparatus of claim 1, wherein the driving device is formed in a main body of the vacuum cleaner.

6. A dust separating apparatus housed in a corresponding receiving space defined within a main body of a vacuum cleaner to separate dust particles from an air stream, the dust separating apparatus comprising:
a cyclone separator;
a dust receptacle arranged below the cyclone separator to form a dust collecting space, and to receive the dust particles separated in the cyclone separator;
a driving device formed in the main body of the vacuum cleaner; and
a driving force transmitting device to transmit a driving force of the driving device to the dust receptacle, wherein
the dust receptacle comprises at least two receptacles, and
the driving device increases or decreases the dust collecting space by moving the at least two receptacles in relation with each other.

7. The dust separating apparatus of claim 6, wherein the dust receptacle comprises a first and second receptacle, in which the first receptacle is secured to the cyclone separator and the first and second receptacles are moved in relation with each other.

8. The dust separating apparatus of claim 7, wherein the dust separating apparatus is in mesh with the driving device when mounted in the main body of the vacuum cleaner, and separated from the driving device when removed from the main body of the vacuum cleaner.

9. The dust separating apparatus of claim 6, wherein the driving force transmitting device comprises a screw member.

10. The dust separating apparatus of claim 6, wherein the driving force transmitting device comprises a rack and a pinion.

11. The dust separating apparatus of claim 6, wherein the driving device is stopped automatically if overload is detected.

12. The dust separating apparatus of claim 6, wherein the cyclone separator is formed in a manner in which an axis of rotation of the drawn air stream is approximately horizontal, and the cyclone separator is connected to the dust collecting space by a dust outlet.

13. The dust separating apparatus of claim 6, wherein the dust receptacle further comprises a compressing member which compresses the dust particles.

14. A dust separating apparatus having an adjustable volume dust collecting space for collecting dust particles separated from an external air stream by a cyclone separator, the dust separating apparatus comprising:
a dust receptacle surrounding a dust collecting space having a volume, the dust receptacle including a first dust receptacle and a second dust receptacle; and
a driving device;
wherein one of the first dust receptacle and the second dust receptacle is movable relative to the other of the first dust receptacle and second dust receptacle to thereby adjust the volume of the dust collecting space.

15. The dust separating apparatus of claim 14, wherein the driving device provides a driving force to move the one of the first dust receptacle and the second dust receptacle relative to the other of the first dust receptacle and second dust receptacle to thereby adjust the volume of the dust collecting space.

16. The dust separating apparatus of claim 15, further comprising:
a driving force transmission device positioned between the driving device and one of the first receptacle and second receptacle.

17. The dust separating apparatus of claim 14, further comprising:
a discharge duct including a discharge duct inner pipe and a discharge duct outer pipe; wherein the discharge outer pipe is moved relative to the discharge duct inner pipe during adjustment of the volume of the dust collecting space.

18. The dust separating apparatus of claim 17, further comprising:
an inlet duct positioned adjacent to, and parallel with, the discharge duct, the inlet duct comprising:
an inlet duct inner pipe; and
an inlet duct outer pipe;
wherein the inlet duct outer pipe is moved relative to the inlet duct inner pipe during adjustment of the volume of the dust collecting space.
